(19) United States
(12) Patent Application Publication
(10) Pub. No.: US 2016/0123232 A1
(43) Pub. Date: May 5, 2016

(54) METHOD AND SYSTEM FOR TURBINE ENGINE TEMPERATURE REGULATION

(71) Applicant: Unison Industries, LLC, Jacksonville, FL (US)

(72) Inventors: Scott Brian Wright, Ponte Vedra Beach, FL (US); James Robert Turner, Jacksonville, FL (US)

(21) Appl. No.: 14/532,829

(22) Filed: Nov. 4, 2014

(51) Int. Cl. F02C 7/22; F02C 7/26

(52) U.S. Cl. CPC F02C 7/22; F02C 7/26

(57) ABSTRACT

A method of starting a turbine engine using turbine temperature gradient regulation and a turbine engine temperature management system are provided. The system includes a temperature sensor, a modulating fuel flow valve, and a temperature controller. The temperature controller is configured to limit a rate of change of the fuel flow to the turbine engine to less than a predetermined maximum rate of change of the fuel flow that will reduce a rate of change of the temperature and maintain a positive rate of change of a rotational speed of the turbine engine and limit a rate of the fuel flow to greater than a predetermined minimum rate of the fuel flow that maintains a positive rate of change of temperature and a positive rate of change of the rotational speed of the turbine engine.

### BACKGROUND

This description relates to turbine engine controls, and, more particularly, to a method and system for turbine engine starting with inter-turbine temperature (ITT) gradient regulation.

At least some known turbine engine systems monitor temperature signals, such as, but, not limited to, an inter-turbine temperature (ITT) signal, which is supplied from an inter-turbine temperature sensor positioned between the high pressure turbine and the low pressure turbine in the turbine engine and a temperature signal from an exhaust gas temperature (EGT) sensor positioned at the outlet of the low pressure turbine. During a startup or during load changes on the turbine engine, the ITT gradient typically changes at a rate determined by many factors relating to the combustion process parameters and the physics of the particular configuration of the physical components in and adjacent to the gas path through the high pressure turbine and the low pressure turbine. Known turbine engines do not intervene or control ITT gradients during a starting sequence for the turbine engine, but may regulate to a predetermined maximum allowable temperature. Rapid changes in the ITT gradient can add stress to the turbine components due to repeated thermal shock.

Some small turbine/turboprop engines are known to use electronic intervention, which does monitor the rate of change of ITT and utilizes a comparator to determine an exceedance with respect to rate of change of ITT. Based on the exceedance, a binary activated fuel valve is commanded to deliver fixed, binary reductions in fuel flow when the threshold is exceeded. These fixed reductions, applied abruptly, tend to cause sharp changes in the ITT temperature and stall the acceleration of the engine to ground idle speed. These fuel flow interventions typically occur several times within the first few seconds of engine light-off until the ITT gradient reaches equilibrium below a predetermined exceedance threshold. Excessive magnitude, rapid changes and/or oscillations in ITT temperature can thermal shock the turbine components, eventually leading to limited life and potential damage.

### BRIEF DESCRIPTION

In one embodiment, a turbine engine temperature management system includes a temperature sensor configured to sense a turbine engine temperature, a modulating fuel flow valve configured to control a fuel flow to the turbine engine, and a temperature controller. The temperature controller is configured to limit a rate of change of the fuel flow to the turbine engine to less than a predetermined maximum rate of change of the fuel flow that will reduce a rate of change of the temperature and maintain a positive rate of change of a rotational speed of the turbine engine and limit a rate of the fuel flow to greater than a predetermined minimum rate of the fuel flow that maintains a positive rate of change of temperature and a positive rate of change of the rotational speed of the turbine engine.

In another embodiment, a method of starting a turbine engine using inter-turbine temperature (ITT) gradient regulation includes receiving a signal representative of an inter-turbine temperature (ITT) of a turbine engine, determining a rate of change of the ITT, and comparing the determined rate of change of the ITT to a predetermined rate of change of the ITT threshold. The method further includes limiting the resultant of the comparison to less than a predetermined maximum rate of change of a fuel flow to the turbine engine that will reduce the rate of change of the ITT and maintain a positive rate of change of a rotational speed of the turbine engine. The method also includes determining a rate of fuel flow to the turbine engine corresponding to the limited rate of change of the fuel flow, limiting the determined rate of the fuel flow to greater than a predetermined minimum rate of the fuel flow that maintains a positive rate of change of ITT and a positive rate of change of the rotational speed of the turbine engine, and controlling a fuel flow to the turbine engine based on the limited determined rate of the fuel flow.

In yet another embodiment, a temperature management system for a gas turbine engine assembly includes a temperature sensor, a temperature management controller that includes a temperature rate of change error circuit communicatively coupled to the temperature sensor, a fuel flow rate of change limiter communicatively coupled to the temperature rate of change error circuit, and a fuel flow rate limiter communicatively coupled to the fuel flow rate of change limiter through an integrator circuit. The system also includes a fuel system including a modulating fuel flow valve communicatively coupled to the fuel flow rate limiter, the fuel flow valve configured to control a fuel flow to the turbine engine based on a signal from the fuel flow rate limiter.

### BRIEF DESCRIPTION OF THE DRAWINGS

FIGS. 1-4 show example embodiments of the method and apparatus described herein.

FIG. 1 is a schematic block diagram of an inter-turbine temperature (ITT) gradient management system in accordance with an example embodiment of the present disclosure.

FIG. 2 is a graph of ITT during a representative startup of the turbine engine shown in FIG. 1 and a graph of fuel flow W_{f} during the startup without using the ITT gradient management system shown in FIG. 1.

FIG. 3 is a graph of ITT during a startup of the turbine engine shown in FIG. 1 and a graph of fuel flow W_{f} during the startup in accordance with an example embodiment of the present disclosure.

FIG. 4 is a flow chart of a method of managing inter-turbine temperature in the turbine engine shown in FIG. 1.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems including one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to analytical and methodical embodiments of modulating fuel flow to a gas turbine engine to control a rate of change of inter-turbine temperature in industrial, commercial, and residential applications.

Embodiments of the present disclosure describe a method of regulating fuel flow in response to excessive inter-turbine temperature gradient conditions with limited changes in the commanded fuel metering valve flow rate during the engine starting sequence. The control sequence operates such that negative (speed or temperature) transitions are avoided during the scheduled speed increases during the start, utilizing an interaction sequence balancing the time of the fuel intervention and the amount of the fuel inhibited through the fuel metering valve. The implementation is facilitated with circuitry pre-configured for engine fuel metering valve fuel flow and engine starting speed algorithms. Engine mechanical life benefits from reduced thermal stress during engine starts is expected from the elimination of aggressive temperature transitions experienced during typical starting.

The method measures the rate change in the engine inter-turbine temperature (ITT) and reduces fuel flow if the rate change exceeds a maximum threshold. The amount of the fuel reduction, the slope at which the fuel flow drops and recovers, and the ultimate duration of the fuel reduction are all constrained by the control system implementation to gently reduce the temperature rate of change, or gradient, without causing a reversal of the temperature (negative gradient) or stalling of the engine (negative change in core engine speed).

The method actively manages hot starts of the turbine engine and can ultimately limit the maximum temperatures achieved, preventing exceedances, which could cause immediate or latent damage to the turbo-machinery. The method extends the life of the turbine engine, allowing for longer times between scheduled inspection and repairs, which results in lower overall ownership and maintenance costs. This method's implementation of ITT gradient management serves to prevent or reduce prolonged operation in the turbine engine's flat spot, which creates a discontinuity in the engine response and won't allow it to accelerate as required. The manipulation of the engine fuel flow is contained within reasonable limits such that the acceleration of engine speed is not stifled in an attempt to control the ITT temperature.

The following description refers to the accompanying drawings, in which, in the absence of a contrary representation, the same numbers in different drawings represent similar elements.

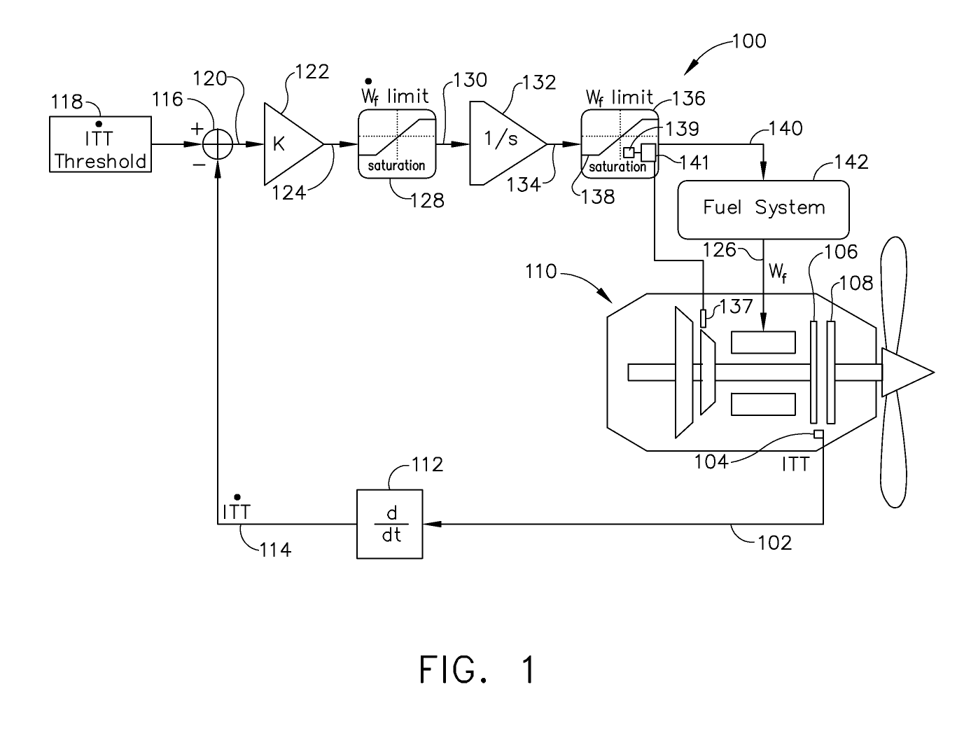

FIG. 1 is a schematic block diagram of an inter-turbine temperature (ITT) gradient management system 100. In the example embodiment, an inter-turbine temperature (ITT) signal 102, which is supplied from an inter-turbine temperature sensor 104 positioned between a high pressure turbine 106 and a low pressure turbine 108 of, for example, but not limited to, a free turbine engine 110. Signal 102 is processed using a differentiator or derivative circuit 112 to provide a signal 114 representative of the rate of change of ITT, (ITT-Dot). ITT-Dot signal 114 is input to a comparator 116 where it is compared to a predetermined ITT-Dot threshold value 118, which sets the maximum rate change of ITT that is acceptable. Comparator 116 generates an ITT-Dot error signal 120 that is multiplied by a gain, k in an amplifier 122. When ITT-Dot signal 114 exceeds ITT-Dot threshold value 118, an output 124 of amplifier 122 is negative, which tends to drive fuel flow rate (W_{f}) 126 down. The rate at which fuel flow (W_{f}) 126 is reduced is proportional to the measured exceedances represented by ITT-Dot error signal 120. A first W_{f}-Dot saturation limiter 128 sets a maximum rate of change for fuel flow, W_{f} 126, such that the rate of fuel reduction is less than a predetermined maximum, which could result in an undesired response in ITT. The saturation limited W_{f}-Dot signal 130 is then processed by an integrator 132 to produce a desired fuel flow rate signal 134 proportional to the desired flow rate, W_{f} 126. A magnitude of desired flow rate, W_{f} 126 is bound by a second Delta-W_{f} saturation limiter 136 (which may be implemented using minimum-maximum selectors against scheduled limits that vary based on the turbine engine core operating speed). A core engine speed detector 137 is used to provide the turbine engine core operating speed. An analog schedule or memory table 139 includes the selections that are made based on the turbine engine core operating speed by a max-min selector 141. Second Delta-W_{f} saturation limiter 136 is configured to prevent desired fuel flow rate signal 134 from exceeding predetermined boundaries, which are set appropriate for the engine operating mode.

During a start sequence, when ITT gradient management system 100 is designed to operate, a lower threshold 138 provides a maximum reduction in fuel flow, Delta-W_{f}, from a nominal start flow rate. A final output 140 is converted from an electronic signal to an actual fuel flow rate by an engine fuel system 142.

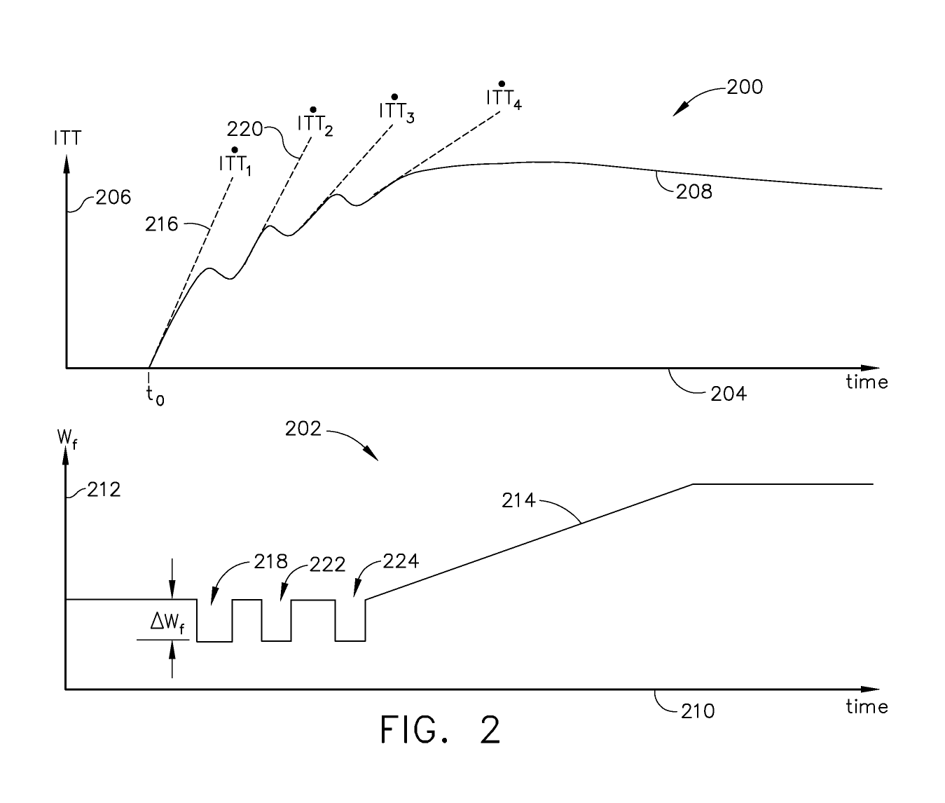

FIG. 2 is a graph 200 of ITT during a representative startup of turbine engine 110 (shown in FIG. 1) and a graph 202 of fuel flow W_{f} during the startup without using ITT gradient management system 100. Graph 200 includes an x-axis 204 graduated in units of time (seconds) and a y-axis 206 graduated in units of temperature. A trace 208 illustrates the ITT during the startup.

Graph 202 includes an x-axis 210 graduated in units of time (seconds) and a y-axis 212 graduated in units of flow. A trace 214 illustrates the fuel flow W_{f} to turbine engine 110 during the startup.

When initial light-off (t₀) occurs, an ITT gradient (ITT-Dot1) 216 (i.e., a slope of trace 208) at t₀ typically exceeds a desired threshold (i.e. the slope of trace 208 exceeds the threshold). Based on a comparison of ITT-Dot1 216 to the threshold, a binary activated fuel valve in fuel system 142 is commanded to deliver a fixed, binary reduction 218 in fuel flow when the threshold is exceeded. This fixed reduction 218, applied abruptly, tends to cause sharp changes in ITT trace 208 and stall the acceleration of the engine to ground idle speed. Similarly, when ITT recovers after fuel flow is restored, an ITT gradient (ITT-Dot2) 220 again exceeds the threshold causing the binary activated fuel valve in fuel system 142 to close again in a fixed reduction 222 of fuel flow. ITT again is reduced before the comparator can open the binary activated fuel valve, restoring fuel flow and increasing ITT. These fuel flow reductions 218, 222, and 224 typically occur several times within the first few seconds of engine light-off until the ITT gradient reaches equilibrium below the predetermined exceedance threshold.

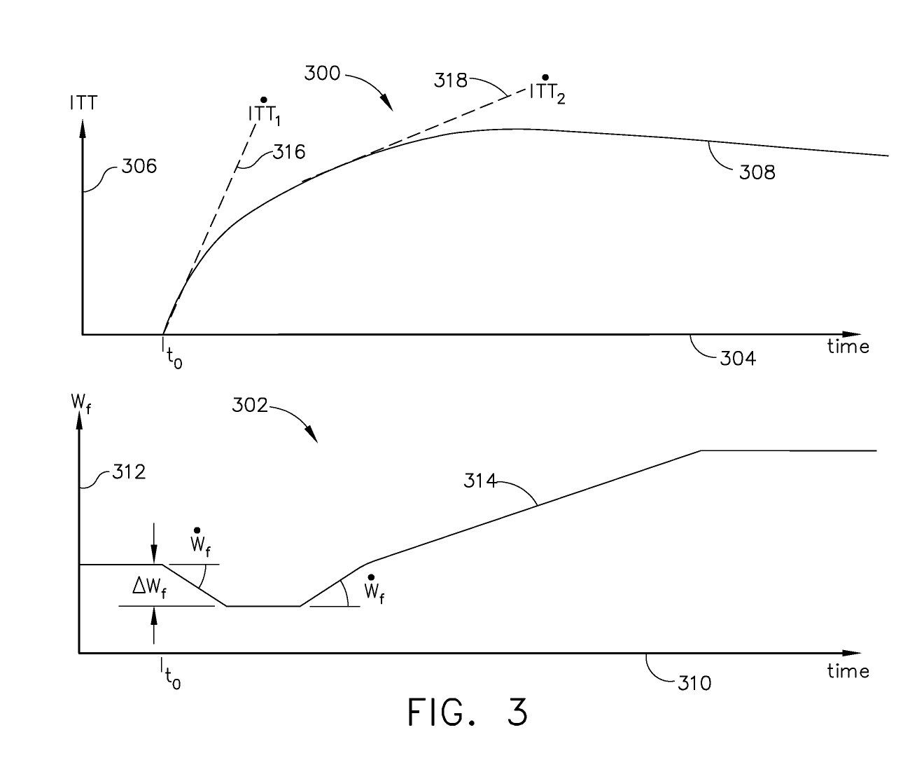

FIG. 3 is a graph 300 of ITT during a startup of turbine engine 110 (shown in FIG. 1) and a graph 302 of fuel flow W_{f} during the startup in accordance with an example embodiment of the present disclosure. Graph 300 includes an x-axis 304 graduated in units of time (seconds) and a y-axis 306 graduated in units of temperature. A trace 308 illustrates the ITT during the startup.

Graph 302 includes an x-axis 310 graduated in units of time (seconds) and a y-axis 312 graduated in units of flow. A trace 314 illustrates the fuel flow W_{f} to turbine engine 110 during the startup.

ITT gradient management system 100, is one controller element of many that includes an Electronic Engine Control (EEC) (not shown) for turbine engine 110, which may include a core speed governor, scheduled fuel flow limiters for start flow and overspeed prevention, and other limiting regulators (for torque, ITT magnitude or propeller speed, for example). The EEC determines which of these plurality of regulators drives a output via a min-max selection process. The results of this approach are illustrated in FIG. 3.

When initial light-off (t₀) of turbine engine 110 occurs, an ITT gradient (ITT-Dot1) 316 at t₀ typically exceeds a desired threshold (i.e. a slope of trace 308 exceeds the threshold). The EEC, employing this method, makes a calculated reduction in fuel flow rate, W_{f} bound by first W_{f}-Dot saturation limiter 128 and second Delta-W_{f} limiter 136, until the closed-loop feedback confirms an ITT gradient (ITT-Dot2) 318 has shifted below the exceedance threshold.

Rather than a series of abrupt binary reductions in fuel flow to reduce the ITT gradient during startup, the present method uses a calculated reduction to turn the rate of change of ITT in a controlled manner to provide a smooth transition of ITT from cold iron temperatures to ground idle speed of turbine engine 110. ITT gradient management system 100 measures the rate change in the engine inter-turbine temperature (ITT) and reduces fuel flow if the rate change exceeds a maximum threshold. The amount of the fuel reduction, the slope at which the fuel flow drops and recovers, and the ultimate duration of the fuel reduction are all constrained by the control system implementation to gently reduce the temperature rate of change, or gradient, without causing a reversal of the temperature (negative gradient) or stalling of the engine (negative change in core engine speed).

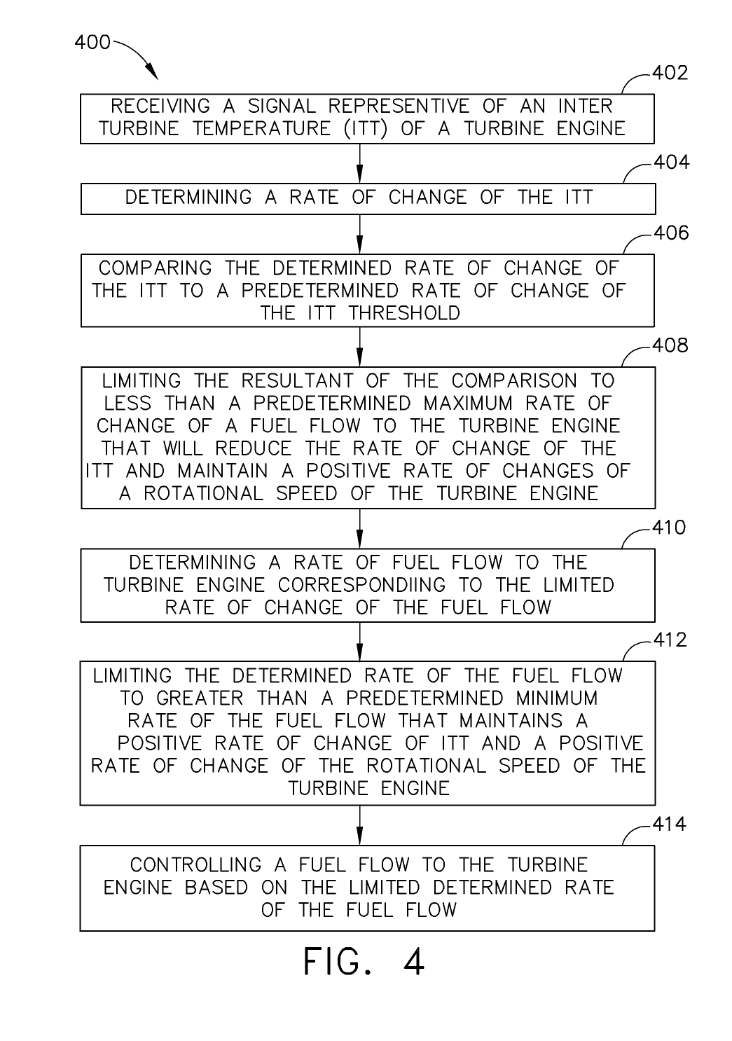

FIG. 4 is a flow chart of a method 400 of managing inter-turbine temperature in turbine engine 110 (shown in FIG. 1). In the example embodiment, method 400 includes receiving 402 a signal representative of an inter-turbine temperature (ITT) of a turbine engine, determining 404 a rate of change of the ITT, comparing 406 the determined rate of change of the ITT to a predetermined rate of change of the ITT threshold, and limiting 408 the resultant of the comparison to less than a predetermined maximum rate of change of a fuel flow to the turbine engine that will reduce the rate of change of the ITT and maintain a positive rate of change of a rotational speed of the turbine engine. Method 400 also includes determining 410 a rate of fuel flow to the turbine engine corresponding to the limited rate of change of the fuel flow, limiting 412 the determined rate of the fuel flow to greater than a predetermined minimum rate of the fuel flow that maintains a positive rate of change of ITT and a positive rate of change of the rotational speed of the turbine engine. Method 400 further includes controlling 414 a fuel flow to the turbine engine based on the limited determined rate of the fuel flow.

The above-described embodiments of a method and system of regulating fuel flow in response to excessive inter-turbine temperature gradient conditions during the turbine engine starting sequence provides a cost-effective and reliable means for avoiding negative (speed or temperature) transitions during the scheduled speed increases during the turbine engine starting sequence. More specifically, the methods and systems described herein facilitate balancing the time of the fuel intervention and the amount of the fuel inhibited through the fuel metering valve. In addition, the above-described methods and systems facilitate measuring the rate change in the engine inter-turbine temperature (ITT) and reducing fuel flow if the rate change exceeds a maximum threshold. The amount of the fuel reduction, the slope at which the fuel flow drops and recovers, and the ultimate duration of the fuel reduction are all constrained by the control system implementation to gently reduce the temperature rate of change, or gradient, without causing a reversal of the temperature (negative gradient) or stalling of the engine (negative change in core engine speed). As a result, the methods and systems described herein facilitate actively managing starts of the turbine engine and limiting the maximum temperatures achieved, preventing exceedances, which could cause immediate or latent damage to the turbine engine in a cost-effective and reliable manner.

Example methods and apparatus for managing a turbine engine ITT gradient are described above in detail. The apparatus illustrated is not limited to the specific embodiments described herein, but rather, components of each may be utilized independently and separately from other components described herein. Each system component can also be used in combination with other system components.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine temperature management system comprising:
a temperature sensor configured to sense a turbine engine temperature;
a modulating fuel flow valve configured to control a fuel flow to the turbine engine; and
a temperature controller configured to:
limit a rate of change of the fuel flow to the turbine engine to less than a predetermined maximum rate of change of the fuel flow that will reduce a rate of change of the temperature and maintain a positive rate of change of a rotational speed of the turbine engine; and
limit a rate of the fuel flow to greater than a predetermined minimum rate of the fuel flow that maintains a positive rate of change of temperature and a positive rate of change of the rotational speed of the turbine engine.

2. The system of claim 1, wherein said temperature controller is configured to:
receive a signal representative of a temperature sensed by said temperature sensor;
determine a rate of change of the sensed temperature signal; and
compare the determined rate of change of the sensed temperature signal to a predetermined temperature rate of change threshold to generate a temperature rate of change error signal.

3. The system of claim 2, wherein said temperature controller is further configured to determine a rate of change of the sensed temperature signal using a derivative circuit.

4. The system of claim 2, wherein said temperature controller is further configured to apply a predetermined gain to the temperature rate of change error signal to generate a corresponding fuel flow rate of change signal.

5. The system of claim 1, wherein said temperature management system comprises a fuel system configured to control an amount of fuel flow to the turbine engine, the temperature sensor positioned between a first turbine and a second turbine of the turbine engine.

6. The system of claim 1, wherein said temperature controller is further configured to integrate the limited fuel flow rate of change signal to generate a fuel flow rate signal.

7. The system of claim 6, wherein said temperature controller is further configured to transmit the limited fuel flow rate signal to said modulating fuel valve.

8. The system of claim 1, wherein said temperature controller is further configured to limit the determined rate of the fuel flow comprises using minimum-maximum selectors against scheduled limits that vary based on the turbine engine core operating speed.

9. The system of claim 1, wherein said temperature controller comprises a processor communicatively coupled to a memory.

10. A method of starting a turbine engine using turbine temperature gradient regulation, said method comprising:
receiving a signal representative of a temperature in the gas path of a turbine engine;
determining a rate of change of the temperature;
comparing the determined rate of change of the temperature to a predetermined rate of change of the temperature threshold;
limiting the resultant of the comparison to less than a predetermined maximum rate of change of a fuel flow to the turbine engine that will reduce the rate of change of the temperature and maintain a positive rate of change of a rotational speed of the turbine engine;
determining a rate of fuel flow to the turbine engine corresponding to the limited rate of change of the fuel flow;
limiting the determined rate of the fuel flow to greater than a predetermined minimum rate of the fuel flow that maintains a positive rate of change of temperature and a positive rate of change of the rotational speed of the turbine engine; and
controlling a fuel flow to the turbine engine based on the limited determined rate of the fuel flow.

11. The method of claim 10, wherein the received a signal representative of a temperature in the gas path of a turbine engine is an inter-turbine temperature signal from a sensor positioned between a high pressure and a low pressure turbine.

12. The method of claim 10, wherein determining a rate of change of a fuel flow comprises comparing the rate of change of the temperature to a predetermined maximum rate of change of the temperature.

13. The method of claim 10, wherein determining a rate of change of a fuel flow comprises limiting the rate of change of the fuel flow to a predetermined maximum rate of change of the fuel flow.

14. The method of claim 10, further comprising determining a rate of fuel flow to the turbine engine corresponding to the limited rate of change of the fuel flow comprises integrating the determined rate of fuel flow to the turbine engine.

15. The method of claim 10, wherein limiting the determined rate of the fuel flow comprises using minimum-maximum selectors against scheduled limits that vary based on the turbine engine core operating speed.

16. A temperature management system for a gas turbine engine assembly, the system comprising:
a temperature sensor;
a temperature management controller comprising:
a temperature rate of change error circuit communicatively coupled to said temperature sensor;
a fuel flow rate of change limiter communicatively coupled to said temperature rate of change error circuit;
a fuel flow rate limiter communicatively coupled to said fuel flow rate of change limiter through an integrator circuit; and
a fuel system comprising a modulating fuel flow valve communicatively coupled to said fuel flow rate limiter, said fuel flow valve configured to control a fuel flow to the turbine engine based on a signal from said fuel flow rate limiter.

17. The system of claim 16, wherein said temperature sensor is positioned in a gas path of a gas turbine engine between a high pressure turbine and a low pressure turbine.

18. The system of claim 16, wherein said temperature rate of change error circuit comprises a derivative circuit configured to generate a rate of change of the temperature and a comparator configured to generate an error signal representative of a difference between a temperature rate of change threshold value and the generated rate of change of the temperature.

19. The system of claim 16, further comprising an amplifier configured to convert a temperature rate of change error signal from said temperature rate of change error circuit to a fuel flow rate of change signal, the fuel flow rate of change signal corresponding to an amount of a change in a fuel flow determined to mitigate the temperature rate of change error signal, maintain a positive rate of change of the temperature, and maintain a positive rate of change of the rotational speed of the turbine engine.

20. The system of claim 16, wherein said fuel flow rate of change limiter is configured to limit said fuel flow rate of change, such that the rate of fuel reduction is less than a predetermined maximum, the maximum rate of change for the fuel flow based at least partially on flow characteristics of the fuel system and an inertia model for the turbine engine.

21. The system of claim 16, wherein said fuel flow rate limiter is configured to limit the fuel flow rate to maintain a positive rate of change of the temperature, and maintain a positive rate of change of the rotational speed of the turbine engine.

22. The system of claim 16, wherein said fuel flow rate limiter comprises a model of the flow characteristics of the fuel system and an inertia model for the turbine engine.
